(19) United States
(12) Patent Application Publication
(10) Pub. No.: US 2009/0010415 A1
(43) Pub. Date: Jan. 8, 2009

(54) Method for call waiting

(76) Inventor: Todd R. Ustby, Rochester, MN (US)

Correspondence Address: Dunlap & Seeger, P.A.;Suite 505, 206 South Broadway, P.O. Box 549, Rochester, MN, 55903-0549, US

(21) Appl. No.: 11/824,342

(22) Filed: Jul. 2, 2007

(51) Int. Cl. H04M 3/42

(52) U.S. Cl. 379/215.01

(57) ABSTRACT

An improved call waiting process is provided wherein the called party (user) may elect to transfer the calling party (second caller) to a disposition option wherein a recorded message invites the second caller to elect to remain on hold until the first call is finished or to be transferred to the user's voicemail. If the second caller elects to remain on hold, the second call is placed on hold until the first call is terminated and the second call completed to the user. While the second call is holding, the recorded message is repeated at predetermined intervals. If the second caller elects to continue to remain on hold, the cycle repeats itself over the predetermined interval. If the second caller elects to leave a message, the second call is transferred to the user's voicemail where he/she can leave a message and the second call is terminated upon completion of the message.

### BACKGROUND OF THE INVENTION

The present invention relates to an improved method for handling incoming calls when the party being called is engaged in another call.

### DESCRIPTION OF THE PRIOR ART

“Call waiting” is a feature that has been offered by the providers of telephone communication services for quite some time. In its most basic form, call waiting involves sending an audible signal to a party engaged in a phone call (the “user”) when the user receives a second, incoming call. Upon receipt of such a signal, the user has the option to either elect to take the second call and place the first caller on hold by pressing a button on the user's phone or to ignore the second call, in which case the second caller receives a busy signal or is transferred to a voice message system in which the second caller is informed that the user is unable to take his/her call and invited to leave a message on a recording.

There are a number of variations on the basic call waiting feature. These variations generally fall into one or both of two types of processes. In one, the user is provided with various disposition options to which he/she can direct the second call. In the other, information is provided to the user concerning the identity of the second caller so that the user (or the phone system) can determine how to handle the second call (i.e., accept it, reject it, send it to one of a number of different disposition options). The following patents are illustrative of the prior art.

In U.S. Pat. No. 4,661,975, a call waiting process is described wherein the user has the option to take the second call and place the first caller on hold (as in basic call waiting) or, by selecting various keys on his/her phone, to elect various other treatments of the second call, such as connecting the second call to a busy signal, connecting the second call to a pre-recorded message, or connecting the second call to another phone or calling station.

In U.S. Pat. No. 5,263,084, a call waiting process is described wherein information relating to the identification of the second caller is spontaneously transmitted to the user to allow the user to accept or reject the second call based on such information.

In U.S. Pat. No. 5,309,512, a call waiting process is described wherein, in addition to alerting the user of a second incoming call, the user is provided with information as to the origin of the second incoming call so that the user is better able to decide whether to accept or reject the second incoming call.

In U.S. Pat. No. 5,425,092, a call waiting process is described wherein information relating to the identification of the second caller is used by the phone system to determine whether or not a call waiting signal is transmitted to the user.

In U.S. Pat. No. 5,680,447, a call waiting process is described wherein the user has the option to take the second call and place the first caller on hold (as in basic call waiting) or, by selecting one of various keys on his/her phone, to connect the second caller to a variety of pre-recorded messages, the specific message depending upon the key that is selected by the user.

In U.S. Pat. No. 5,848,142, a call waiting process is described wherein, in addition to the basic options of accepting or rejecting the incoming call, the user is given the options of (1) rejecting the incoming call with a message to the second caller to call again after a pre-determined time, (2) rejecting the incoming call with a message to the second caller that the user will return the call after a pre-determined time, (3) conferencing the second call into the first call, (4) directing that the second call be transferred to another phone or voicemail, or (5) disabling the call waiting feature.

In U.S. Pat. No. 6,415,026, a call waiting process is described wherein information concerning the identity of the second caller is processed by the phone system to determine how the second call is processed, based on a number of parameters set by the user. If the second call does not correspond to any of the selected parameters, the second call is handled with basic call waiting. If the second call corresponds to any of the parameters, the system determines which of a number of options should be selected for that call.

In U.S. Pat. No. 6,954,521, a call waiting process is described wherein information concerning the identity of the second caller is provided to the user in audible form. The user then has the option to send the second call to a number of disposition options.

In U.S. Pat. No. 7,095,826, a call waiting process is described wherein the user is provided with recorded (audible) information concerning the identity of a second incoming caller when the first call is over.

In U.S. Pat. No. 7,099,452, a call waiting process is described wherein the second caller is provided with an option to either immediately send the user a call-waiting signal or to leave a message that is delivered to the user immediately after the first call is terminated.

In all the call waiting processes of the prior art, the user must initially make a selection between placing the first caller on hold while he/she answers the second call, or rejecting the second call by sending it to one or more disposal options. Having to reject one of the callers in favor of the other is not an optimal solution. On one hand, placing the first caller on hold while the user accepts the second call may be considered to be rude and indicates to the first caller that his/her call is not of primary importance to the user. On the other hand, rejecting the second call often causes the user to lose an opportunity to speak to the second caller, who either has to call the user back or leave a message and wait for the user to call him/her back. In many of these call back instances, one of the parties will have accepted another call or otherwise be unavailable when the return call is made.

A further problem with the call waiting processes of the prior art is that the second caller does not know when the user will be advised of the second call. The user is unable to acknowledge the second call without interrupting the first call.

Another problem with call waiting processes of the prior art is that none provide the second caller with an option as to how his/her call is handled, assuming that the user elects not to accept the second call.

### BRIEF SUMMARY OF THE INVENTION

It is one object of the present invention to provide an improved call waiting process wherein the user may continue speaking to the first caller while placing the second caller on hold and indicating to the second caller that the user will answer the second call as soon as the user is finished with the first call. The second caller is thereby informed that his/her call will be answered shortly.

It is another object of the present invention to provide an improved call waiting process wherein the second caller may select from one or more disposition options for the second call in the event that the user elects not to accept the second call.

To those ends, an improved call waiting process is provided wherein upon receipt of an incoming call, a determination is made as to whether the called number is busy. If the called number is not busy, the call is put through to the called party in the usual manner. If the called number is busy, the called party (user) may elect to transfer the calling party (second caller) to one of two disposition options. The first disposition option is to transfer the second call to the user's voicemail where it is handled in the usual manner. The second disposition is to transfer the second call to a recorded message wherein the user advises the second caller that the user is engaged in a prior call, informs the second caller that his/her call will be answered shortly and invites the second caller to remain on hold until the user is finished with the first call at which time the second call will be put through. If the second call is transferred to the second disposition option, the second call is placed on hold until the first call is terminated and the second call completed to the user. While the second call is holding, a second recorded message is transmitted to the second caller at predetermined intervals advising the second caller that the second call will be completed when the first call is terminated and invites the second caller to remain on hold or to transfer the second call to the user's voicemail to leave a message for the user. If the second caller elects to remain on hold, the cycle repeats itself over the predetermined interval. If the second caller elects to leave a message, the second call is transferred to the user's voicemail where he/she can leave a message and the second call is terminated upon completion of the message.

### DESCRIPTION OF THE DRAWING

FIG. 1 is a flow chart showing the initial process for processing a phone call.

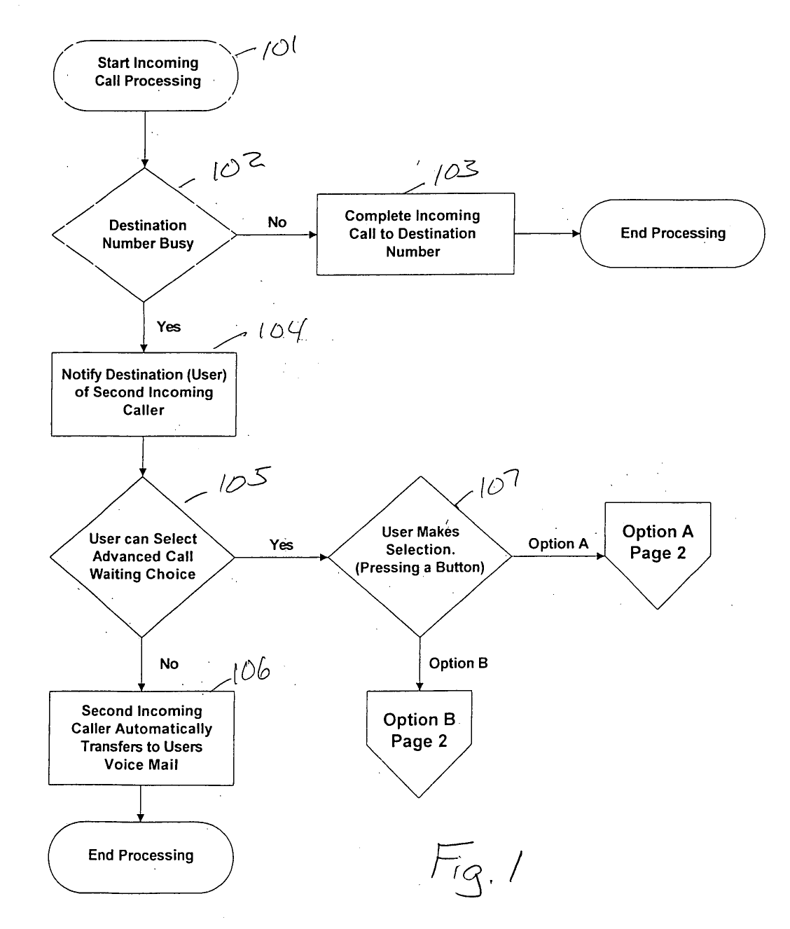

FIG. 2 is a flow chart showing the dispositional options for processing a phone call.

### DETAILED DESCRIPTION OF THE PREFERRED EMBODIMENT

The present invention involves an improved call waiting process for handling an incoming call (“second call”) when the called party (“user”) is engaged in a prior call (“first call”). It is believed that the equipment, circuitry and other mechanics for implementing the process are well known in the art and will not be discussed in any great detail here, the invention being the process and not the means by which it is implemented.

Referring to the drawing, wherein like numerals represent like elements throughout the several views, there is shown a flow chart illustrating the process of the present invention. The process is entered by an incoming call shown at step 101. Upon receipt of an incoming call, a determination is made as to whether the called phone is off hook (i.e., engaged in another call or busy) at step 102. If the called phone is on hook (i.e., not engaged in another call or busy), it is put through to the called phone in the normal fashion at step 103, and the process is terminated in the usual fashion.

If it is determined in step 102 that the called phone is off hook, the user is notified of the incoming call at step 104. The notification may be in any conventional form, such as an audible signal transmitted to the user's handset simply indicating that an incoming call has been received or a voice announcement identifying the incoming caller, a visual signal such as a flashing indicator or a display showing the identity of the caller.

Upon receipt of the notification of the incoming call, the user can select one of two options at step 105. First, he/she can elect to ignore the incoming call by not responding to the notification in the usual fashion or positively select a switch or transfer indicator on his/her phone, in which case the incoming call is transferred at step 106 to the user's voicemail, where it is processed in the usual manner wherein the incoming caller is informed that the user is engaged in another call and invited to leave a message. At that point, the incoming call is terminated in the usual manner.

The second option available to the user is that he/she can elect to activate the improved call waiting feature of the present invention at step 105 by activating either of two switches or transfer indicators, such as by depressing a particular key on his/her phone, as shown at step 107, to elect one of two options for handling the incoming call, shown as Option A or Option B.

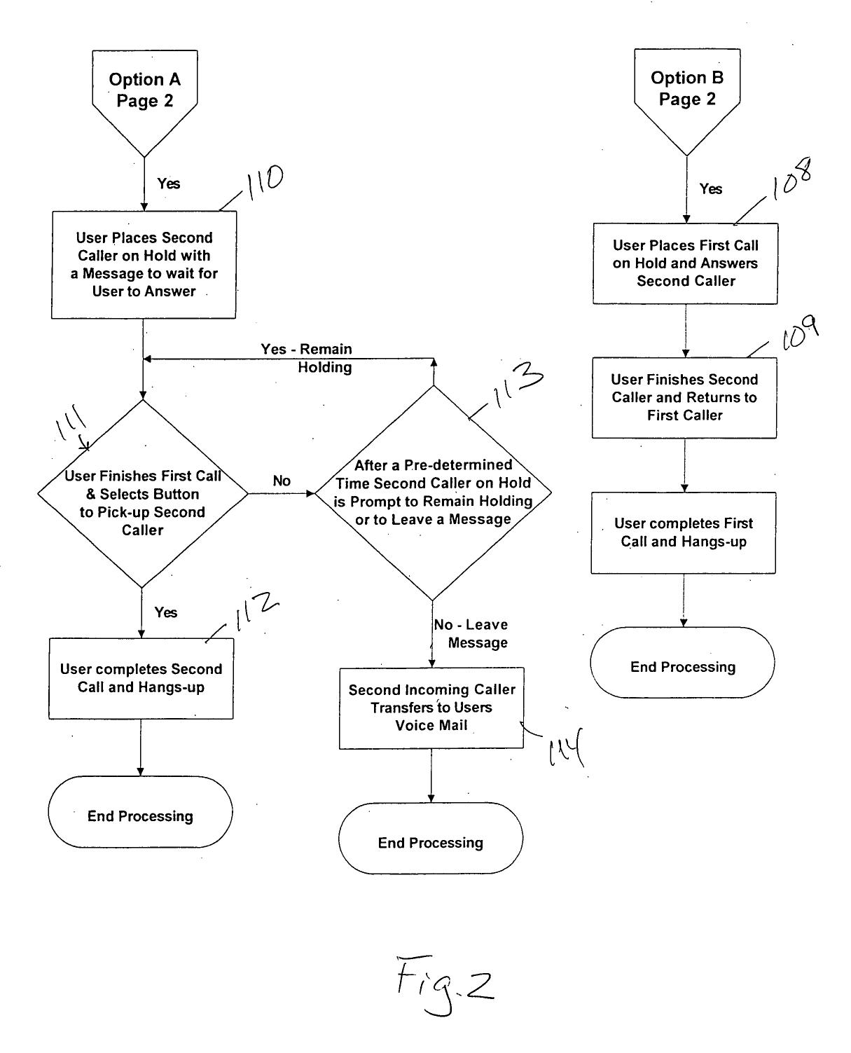

As shown in FIG. 2, if the user elects to activate Option B, the prior caller is placed on hold and the incoming call is answered at step 108. When the incoming call is terminated, the prior call is automatically restored as shown at step 109. Upon restoration of the prior call, that call is handled in the normal manner. This branch of the process is the conventional call waiting process, and up to this point in the process, the various steps are known in the prior art.

If the user selects Option A by activating the appropriate switch, the incoming call is placed on hold and a message is relayed to the incoming caller as shown at step 110. The message will preferably inform the incoming caller that the user is engaged in another call, which the user expects will be terminated shortly, and that the incoming call will be put through to the user as soon as the prior call is terminated. If the prior call is terminated within a predetermined, short time (for instance within 30 seconds of delivery of the message), the user can connect the incoming call at step 111 by activating a connection switch, which results in the incoming call being connected to the user and the call is completed in the normal manner as shown at step 112. If the prior call is not terminated within the predetermined time, another message is relayed to the incoming caller at step 111 which repeats prior message and asks the incoming caller to remain on the line. The second message will also advise the incoming caller that he/she may elect to not remain on the line, in which case the incoming call will be transferred to the user's voicemail so that the incoming caller can leave a message. Having received the second message, the incoming caller may elect to stay on the line or to be transferred to the user's voicemail as shown at step 113. The incoming caller may elect to stay on the line by doing nothing or by generating an appropriate signal on his/her phone (i.e., by depressing a specific key on his/her phone). If the incoming caller elects to remain on hold, the sequence is repeated again at the end of another predetermined interval. In this manner, the incoming caller may elect to remain on hold as long as he/she is willing.

If the incoming caller elects at step 113 to leave a message, he/she indicates such election by generating an appropriate signal on his/her phone (i.e., by depressing another specific key on his/her phone). Upon receipt of such signal, the user's system transfers the incoming call to the user's voicemail as shown at step 114 where the incoming caller can leave a message for the user and the incoming call is terminated in the usual manner.

While I have described the preferred embodiment of my invention, it will be evident to those skilled in the art that other embodiments may be possible within the scope of my invention.

What is claimed is:

1. An improved method of processing an incoming call from a calling party to a called party when the called party is engaged in a conversation with a prior caller, wherein upon notification of receipt of an incoming call, the called party is given options which may be activated on the called party's phone as to how to process the incoming call, wherein one of said options comprises the steps of:
(a) transferring the calling party to a message which informs the calling party that the called party is engaged in a prior call, that if the calling party remains on the line, the incoming call will be answered upon termination of the prior call, and that if the calling party does not wish to remain on the line, the calling party may be transferred to a message system wherein the calling party may leave a message for the called party; and
(b) if the calling party elects to remain on the line,
(i) placing the incoming call on hold and repeating said message to the calling party at predetermined intervals, and
(ii) connecting the calling party to the called party upon termination of the prior call; or
(c) if the calling party does not elect to remain on the line, transferring the calling party to a voice message system where the calling party may leave a message for the called party.

2. An improved method of processing an incoming call from a calling party to a called party when the called party is engaged in a conversation with a prior caller, comprising the steps of:
(a) signaling the called party of the existence of an incoming call and affording the called party with an option to transfer the incoming call to a first processing option or a second processing option by activation of a suitable selection means on the called party's phone;
(b) if said first processing option is selected, transferring the calling party to a voice message system wherein the calling party can leave a message for the called party;
(c) if said second processing option is selected, transferring the calling party to a message which informs the calling party that the called party is engaged in a prior call, that if the calling party remains on the line, the incoming call will be answered upon termination of the prior call, and that if the calling party does not wish to remain on the line, the calling party may be transferred to a voice message system wherein the calling party may leave a message for the called party;
(d) if the calling party elects to remain on the line, placing the incoming call on hold and repeating said message to the calling party at predetermined intervals, and connecting the calling party to the called party upon termination of the prior call; or
(e) if the calling party does not elect to remain on the line, transferring the calling party to a voice message system where the calling party may leave a message for the called party.
